(19) United States
(12) Patent Application Publication
(10) Pub. No.: US 2022/0101735 A1
(43) Pub. Date: Mar. 31, 2022

(54) SYSTEM AND METHOD FOR NAVIGATION OF UNMANNED AERIAL VEHICLES USING MOBILE NETWORKS

(71) Applicant: AT&T Intellectual Property I, L.P., Atlanta, GA (US)

(72) Inventors: Mehdi Malboubi, San Ramon, CA (US); Abhijeet Bhorkar, Fremont, CA (US); Baofeng Jiang, Pleasanton, CA (US)

(21) Appl. No.: 17/039,310

(22) Filed: Sep. 30, 2020

(51) Int. Cl. G08G 5/00; H04W 4/44; B64C 39/02; G05D 1/10

(52) U.S. Cl. CPC G08G 5/0034; G08G 5/006; G08G 5/0004; G08G 5/0069; G08G 5/0039; B64C 2201/14; G08G 5/0026; H04W 4/44; B64C 39/024; G05D 1/1062; B64C 2201/027; G08G 5/0082

(57) ABSTRACT

A method includes receiving a request to create an optimal flight path for an unmanned aerial vehicle (UAV), wherein the request includes an origin and a destination of a UAV flight, receiving an indicator of network loading between the origin and destination, determining if there is a no-fly zone between the origin and the destination, creating a softwall surrounding the no-fly zone based on the identifying step, generating the optimal flight path for the UAV based on the indicator and avoidance of the softwall, and transmitting the optimal flight path to the UAV.

### TECHNICAL FIELD

This disclosure is directed to systems and methods for existing terrestrial 4G and beyond cellular wireless technologies to support unmanned aerial vehicles (UAVs).

### BACKGROUND

Most UAVs are connected to a ground control system via limited range communications systems over unlicensed spectrum. Such connectivity can be prone to congestion, interference, varying range, inconsistent quality of service, and security threats. The non-optimal, insecure and unsafe navigation of these UAVs may result in significant damages and costly interruptions to a variety of public and private services.

The National Aeronautics and Space Administration (NASA) has created an Unmanned Aircraft Systems Traffic Management system (“UTM”) with the goal to create a system that can integrate UAVs safely and efficiently into air traffic that is flying at low altitude. UTM is based on digitally sharing of each user's planned flight details so that each user has the same situational awareness of airspace but at altitudes below which the FAA's Air Traffic Management system operates. This system has additional capabilities to detect and track UAVs. However, the UTM system is primarily based on tracking UAV flights, not active management thereof.

It is anticipated that numerous UAVs owned by various entities need to be operating over wide coverage areas with different requirements and quality of service levels. Mobile networks are well suited to support low-altitude UAV communication and to be integrated with UAV traffic management systems to enhance the safety and security of operations. The licensed mobile spectrum serves as the foundation for mobile networks to provide wide-area, high-quality and secure connectivity that can enable cost-efficient UAV operations beyond visual line-of-sight range to support variety of use cases including mission critical use cases with local line-of-site connectivity. While existing LTE networks may support initial UAV deployments, LTE evolution and 5G will provide more efficient connectivity for wide-scale UAV deployments.

However, there are challenges that must be addressed. One of the main challenges is that the interference caused by these UAVs may have on the mobile communication networks. For examples, UAVs from news outlets need to be efficiently and safely navigated to cover an area while also providing high quality transmissions for videos. Another challenge is fulfilling different customer needs and satisfying their constraints. For example, UAVs from e-commerce companies need to transport objects cost-effectively. Such operations must be carried over mobile/wireless networks and without interrupting other public/private services which may, for example, include restricting flight of UAVs in no-fly zones, and without reducing the quality of services in mobile/wireless networks.

An industry group 3GPP began studies into the implications of serving low altitude UAVs using LTE radios in Release 15 of their standard LTE_Aerial [TR 36.777]. Moreover, the group is developing a framework that will work with UTM described in S1-183464. However, a complete solution for UAV navigation is not yet standardized for mobile wireless networks.

Thus, there is a need to continue the development of systems and methods which permit the adaptation of the mobile networks for the command and control of UAVs without impacting quality of service and other performance metrics, and without interrupting specific public/private services.

### SUMMARY

The present disclosure is directed to a method including receiving a request to create an optimal flight path for an unmanned aerial vehicle (UAV), wherein the request includes an origin and a destination of a UAV flight, receiving an indicator of network performance between the origin and destination, determining if there is a no-fly zone between the origin and the destination, creating a softwall surrounding the no-fly zone based on the identifying step, generating the optimal flight path for the UAV based on the indicator and avoidance of the softwall, and transmitting the optimal flight path to the UAV. The method may further include receiving a priority for a flight of the UAV and wherein generating the optimal flight path is further based on the priority for the flight. In an aspect, generating the optimal flight path is further based on quality of service or further based on a physical limit of the UAV. The method may further include receiving an additional data input and wherein the generating the optimal flight path is further based on the additional input, and wherein the additional data input is one of weather, an emergency or an event or wherein the additional data input relates to a dynamic no-fly zone and the method further comprises creating a softwall surrounding the dynamic no-fly zone, generating an updated optimal flight path, and transmitting the updated optimal flight path to the UAV. In an aspect, the optimal flight path is transmitted to an external system and the transmitting the optimal flight path to the UAV step is based on acceptance of the optimal flight path by the external system.

In an aspect, the method may further include detecting an anomalous UAV, generating an updated optimal flight path further based on the anomalous UAV, and transmitting the updated optimal flight path to the UAV. The method may further include receiving feedback from the UAV, generating an updated optimal flight path further based on the feedback, and transmitting the updated optimal flight path to the UAV and reconfiguring the underlying network based on the indication of network performance.

The disclosure is also directed to a method including receiving an origin and a destination for a flight associated with an unmanned aerial vehicle (UAV), calculating an optimal flight path for the UAV between the origin and the destination, and transmitting the optimal flight path to the UAV, wherein the calculating step comprises optimizing a cost as a function of a variable, wherein the variable is one of the distance between the origin and the destination, a cost associated with encountering obstacles, and network performance metrics. The distance between the origin and the destination is divided into a plurality of segments and wherein any of the plurality of segments within a softwall are excluded from the optimal flight path. In an aspect, the calculating step comprises an optimization technique, wherein the optimization technique is one of linear, convex, non-linear, graph-based and heuristic techniques, or one of using deep neural networks or deep reinforcement learning.

In an aspect, an additional variable may be a constraint by which a travel power level needed to traverse a path being less that an available power level of the UAV or is a priority level of a flight of a UAV or the avoidance of softwalls.

The disclosure is also directed to a system including an input-output interface, a processor coupled to the input-output interface wherein the processor is further coupled to a memory, the memory having stored thereon executable instructions that when executed by the processor cause the processor to effectuate operations including receiving an origin and a destination for a UAV flight, acquiring key performance indicators relating to the UAV flight, identifying constraints associated with the UAV flight, calculating an optimal path for the UAV flight based on the origin and the destination, the key performance indicators, and the constraints, and transmitting the optimal path to the UAV. The operation may further include receiving an additional input after the transmitting step, calculating a revised optimal path based in part on the additional input, and transmitting the revised optimal path to the UAV during the UAV flight. The operations may further include identifying a no-fly zone in proximity of a possible flight path between the origin and the destination, calculating a softwall surrounding the no-fly zone, calculating a revised optimal path based in part on the avoidance of the softwall, and transmitting the optimal path to the UAV.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 is a diagram of an exemplary system architecture in accordance the present disclosure.

FIG. 2 is a diagram of an exemplary system architecture illustrating the UAV Traffic Management and Control module.

FIG. 3A is an exemplary diagram showing two cell sites in communication with UAVs and in communication with an edge cloud.

FIG. 3B is an exemplary diagram of a UAV path avoiding congested areas and no-fly zones.

FIG. 3C is an exemplary diagram showing distributed control of UAVs through edge cloud infrastructure.

FIG. 4A is an exemplary flow chart showing a method of operation from the perspective of a traffic navigation and control system.

FIG. 4B is an exemplary flow chart showing a method of detecting anomalous UAVs by the traffic navigation and control system.

FIG. 4C is an exemplary flow chart showing a method of operation from the perspective of a UAV.

FIG. 5 illustrates a schematic of an exemplary network device.

FIG. 6 illustrates an exemplary communication system that provides wireless telecommunication services over wireless communication networks.

FIG. 7 is a representation of an exemplary network.

FIG. 8 is a representation of an exemplary hardware platform for a network.

### DETAILED DESCRIPTION OF ILLUSTRATIVE EMBODIMENTS

System Overview. This disclosure is directed to a novel and useful application and includes a system and method the intelligent, effective, secure and safe navigation of unmanned aerial vehicles (UAV) or unmanned aerial systems (UAS) over 4G-LTE and 5G networks. It should be noted that the terms UAV for unmanned aerial vehicle and aerial user equipment (aerial UE) will be used interchangeably throughout.

The system and method of the present disclosure provides a complimentary solution that may collaborate and coordinate with UTM and other relevant external sources and agencies. The platform can detect and track UAVs and compute optimal paths for the navigation of UAVs. The optimal paths may be defined by software programs operating on processors and include software-defined geo-restricted walls (softwalls) to prevent any UAVs from entering into no-fly zones, including an additional buffer for safety. The system may also incorporate different constraints into an optimization engine to minimize interference of UAVs on the mobile network's terrestrial users. The system may also provide an optimal path that avoids areas of congestion in the mobile network, determine the shortest path or fastest path between the origin and target destinations of the UAV, and the avoidance of obstacles. In addition, the optimization engine may incorporate custom-defined constraints, such as the power and capacity of UAVs, when computing the optimal paths. Furthermore, the system and method may identify anomalous UAVs, which may, for example, include UAVs trying to enter no-fly zones, unregistered (with the system of the present disclosure or the UTM system) UAVs, and UAVs exhibiting dangerous or abnormal behavior, and generate appropriate alarms.

The system and method disclosed herein may create custom defined optimal paths, which may be referred to as CustPaths, in which an optimal path for the safe navigation of UAVs over mobile/wireless networks are computed using a multi-objective constrained optimization engine. In one embodiment, such optimal paths can mainly guarantee avoiding navigation over no-flying zones. In another embodiment, the CustPath may minimize the interference of UAVs over traditional users of mobile/wireless communication networks. In another embodiment, the CustPath may incorporate customer specific constraints, which may, for example, included the power and capacity of UAVs and minimizing the number of flights for delivering number of items. In another embodiment, the CustPath may incorporate combination of different constraints. These optimal paths may be computed in collaboration and coordination with UAV/UAS Traffic Management (UTM) and other relevant external sources and agencies. The configuration of the underlying mobile/wireless communication network may also be optimally reconfigured to track and localize the UAVs and provide better connectivity for UAVs. All registered and unregistered users or UAV operators may access the optimal path computed by the system and information provided by the system directly via application programming interfaces—after appropriate authentication and authorization—or indirectly via the UTM.

The optimal paths may also be determined based on the priority of the service. Among these, mission critical services may have the highest priority and the FirstNet infrastructure for first responders may be used for navigating these services. Different service levels may be defined, and business or other operational policies may be adopted, for users.

The system and method of the present disclosure may include an interface to the UTM system. In an aspect, the computed optimal paths may be sent to UTM for either approval, update, or rejection. In an aspect, users may register their respective UAVs on a platform including an agreement with respect to terms of use and other contractual requirements. Registered users may access the UAV information, including, for example, location and computed optimal paths, via an API or indirectly through the UTM system. Accordingly, the platform may support multiple different models as set forth herein.

This system and method may detect UAVs and measure the corresponding key performance indicators such as position, altitude, velocity, direction, uplink/downlink throughputs, and other metrics. Information from other sources may be used, including information from the UTM system where the coordinates of no-flying zones and UAV traffic information can be obtained. Additional information, which may, for example, including but not limited to weather information, maps, and KPIs of the underlying mobile network, may be accessed from other sources using gateways and APIs.

Using the global and local information, the disclosed system and method may compute the optimal path(s) for navigating UAVs over mobile communication networks. Optimal paths may be dynamically and collaboratively computed at the edge, regional, and/or central clouds using both local and global information. Other UAS operators and users may obtain the paths from UTM or directly from the disclosed system to allow for inter-network cooperation.

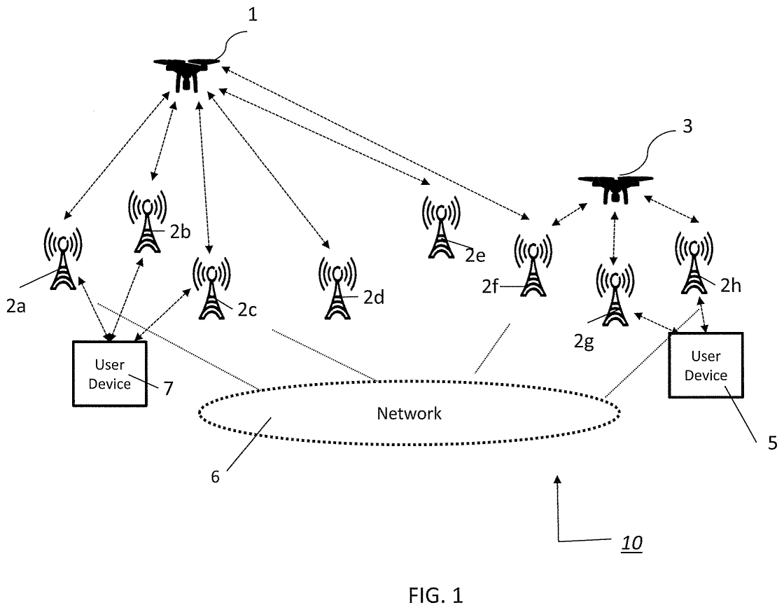

Operating Environment. With reference to FIG. 1, there is shown an exemplary system 10 in which the present disclosure may be implemented. The system 10 may include terrestrial UEs 5, 7 and UAVs 1, 3 connected to a network 6 which may, for example, be any type of wireless network including, fourth generation (4G)/LTE, LTE-Advanced, fifth generation (5G), and any other wireless communication network. It will be understood by those skilled in the art that while the network 6 may comprise the afore-mentioned networks, a combination of one or more communication networks may be used.

Terrestrial user equipment 5, 7, may, for example, be a smartphone, tablet or personal computer configured with an operating system which may, for example, be one of Apple's iOS, Google's Android, Microsoft Windows Mobile, or any other smartphone operating system or computer operating system or versions thereof. The terrestrial UEs 5, 7 may communicate with each other or with UAVs 1 and 3 through network 6. UAVs 1, 3 may be any type of aerial UEs and used for any purpose, including surveillance, audio/video streaming, weather forecasting, communications nodes, deliveries, and any other purpose.

To communicate through the network 6, the terrestrial UEs 5, 7 and UAVs 1, 3 may have a communication interface for a wireless system, which may, for example, be 4G LTE, and 5G, or any other advanced wireless communication interface as understood by those skilled in the art and described in more detail below.

The terrestrial UEs 5, 7 and aerial UEs 1, 3 may communicate to the network 6 by one or more cell sites labeled 2a through 2h. These sites may, for example, be eNodeBs (eNBs) in a 4G/LTE or 5G network. For the purpose of this application, the term “base stations,” “eNodeBs” and “gNodeBs” are used interchangeably. In the exemplary network architecture of FIG. 1 and shown by dashed lines, terrestrial UE 7 may communicate with network 6 through one of eNB 2a, eNB 2b or eNB 2c. Terrestrial UE 5 may communicate with network 6 through one of eNB 2g or eNB 2h. UAV 1 may communicate with network 6 through one or more of eNB 2a, eNB 2b, eNB 2c, eNB 2d, eNB 2e, or eNB 2f. UAV 3, shown at a lower altitude, may be able to communicate with network 6 through one or more of eNB 2f, eNB g, or eNB 2h.

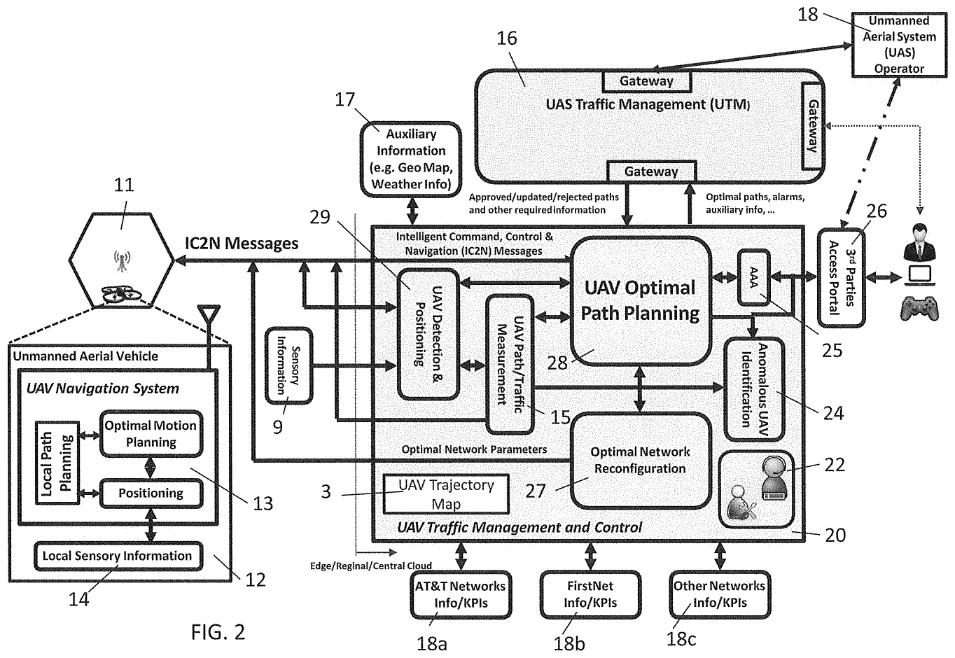

With reference to FIG. 2, there is shown an exemplary block diagram of an architecture of the system of the present disclosure. There is shown a UAV traffic management and control system 20 in communication with a UAV 12 through cellular tower 11 and in communication with a UTM 16 which may, for example, be NASA's UAS traffic management system. The UAV traffic management and control system 20 may communicate with the network using intelligent command, control, and navigation (IC2N) messages.

The UAV traffic and management and control system 20 may work as a compliment to the UTM 16. For example, the optimal path and auxiliary information, including, for example, network KPIs, UAV KPIs, which may, for example, include indicators such as position, height, velocity, direction, and uplink/downlink throughputs, and other information relating to UAVs, anomalous UAVs exhibiting abnormal behaviors, and the like, may be sent to the UTM 16 such that the UTM 16 may approve, update, modify or reject the paths and revert status back to the UAV traffic management and control system 20. Other UAS operators and users may obtain the scheduled paths from the UTM 16 or directly from the UAV traffic management and control system 20. This permits the interoperability between the UTM 16, users of the UAV traffic management and control system 20, and other UAS operators to provide real-time navigation of UAVs with less interference and lower latency in controlling and commanding UAVs over the air.

The UAV traffic management and control system 20 may include a 3^{rd} party access portal 26 which may be accessed by a user or subscriber of the system. The user may be authenticated by an authorization module 25. In an aspect, the user may enter parameters for a UAV 12 flight which may, for example, include origin and destination locations of the UAV 12 flight, quality of service considerations, priority, key performance indicators, maximum range, payload, and other flight or parameters of the UAV 12. The flight parameters may be fed into the UAV optimal path planning module 28. The UAV optimal path panning module may determine the optimal path between the origin and destination locations considering the other parameters as described in more detail below. The UAV optimal path planning module 28 may also interface with an optimal network reconfiguration module 27 which may, for example, include network commands for requesting network access and functionality, including requesting virtual function resources to be instantiated to optimize the configuration of the network in view of the UAV optimal path.

There is shown a UAV path and traffic measurement module 15 in communication with a UAV detection and positioning module 29. Both the UAV path and traffic measurement module 15 and the UAV detection and positioning module 29 are in communication with the UAV optimal path planning module 28. The UAV detection and position module 29 may be configured to detect the position of the UAV 12 being controlled as well as detecting anomalous UAVs that may not be on any particular controlled flight path. In the case of anomalous UAVs, the positioning thereof may be fed back into the UAV optimal path planning module 28 for consideration of possible updates to the optimal path. The position of the anomalous UAVs may be combined with directional measurements and other traffic and passed to an autonomous UAV identification module 24.

The UAV traffic management and control system 20 may communicate with the UTM 16 though a gateway. This communication may include, but is not limited to, the communicating of the path and QoS requirements of UAV 12 to/from the UTM to mobile network; communicating side information of congestion and routes to avoid with respect to cellular operator to/from the UTM system; communicating any abnormal behavior of the UAVs to the UTM system, and communicating updated path information of UAV 12 to the UTM system based on the current congestion in the network.

The UAV traffic management and control system 20 may also have external interfaces, which may, for example, be auxiliary information input at port 17. Such auxiliary information may include weather inputs, geo-mapping data, emergency or other event data, or any other auxiliary information that may impact an optimal route of the UAV 12.

UAV 12 may include a UAV navigation system 13 which is in communication with the network through cellular tower 11. It is through this communication interface that the UAV 12 may receive IC2N messages from the UAV traffic and control module 20. The navigation system 13 may include a local path planner and an optimal path planner, along with a positioning system. The navigation system 13 may also receive local sensory inputs and navigate the UAV by avoiding obstacles. The use of the system of FIG. 2 will be described in more detail below.

An optimal path may be defined as feasible path consisting of a sequence of n connected sub-paths P1, P2 . . . , Pn (out of N sub-paths) that optimizes a defined objective function with multiple constraints. In an embodiment, the optimal path may be the shortest path or the fast path between the origin and target location that avoids approaching fixed/moving obstacles subject to the one or more constraints. For example, the optimal path may prevent hitting Softwalls, the optimal path may have minimal interference over the mobile communication networks, the optimal path may avoid congested traffic areas (created by UAVs or network devices) in the communication networks, the power required for traversing the optimal path must be less than the UAV power supply, and the provided quality of service (QoS) must satisfy the requested service QoS. Such optimization problems can be formulated using different techniques and can be solved using different linear/non-linear and heuristic optimization methods.

The optimal path may be the shortest path or the fastest path, but based on other factors, is not necessarily one of those two options. In one embodiment the optimization can be performed by minimizing the following exemplary formulation to compute the optimal path {P1, P2 . . . , Pn} based on the equation:

$$CustPath = min \{ P 1 , P 2 , … , Pn \} {\sum }_{i = 1}^{n} ( cost of traveling over the i area + ( cost of approaching UAV ( s ) and obstacles in the {i}^{th} local area )$$

Such that the following conditions are met:
The cost of hitting softwalls in the i^{th} local area <c0
Interference over communication network in the i^{th} local area <c1
Congestion based on network loading in the i^{th} local area <c2
Required power for the UAV to traverse the path <the UAV power available
Quality of Service (QoS) for UAS service ≥contracted QoS

Alternatively, or in addition to the exemplary equation above, the optimal path may be implemented using machine learning or artificial intelligence algorithms. A sample data set containing network KPIs, UAV KPIs, softwalls surrounding no-fly zones, priority levels and other data inputs may be used to train a machine learning algorithm. In the case of using machine learning or artificial intelligence, the traffic navigation and control system 20 may have a feedback loop by which the results of the optimal flight path may be evaluated, and the algorithm updated. For example, the feedback may indicate that different KPI thresholds for network congestion should be used based on time of day or modifications to other criteria for mission critical transport should be used. As such, the CustPath algorithm may be constantly evolving to provide greater travel accuracy and more efficient use of power.

In an aspect, the calculating of the optimal path may be performed by an optimization engine. The optimization engine may optimize (i.e. minimize) the cost as a function of a variable, wherein the variable is one of the distance between the origin and the destination, the cost associated with encountering obstacles, and network performance metrics, such as the strength, quality and volume of communication signals to or from the UAV, the load on the network and the impact the UAV may have on the network. In an aspect, the distance between origin and destination may be divided into segments wherein any segments falling within a softwall are excluded and wherein the cost of each segment is optimized. The calculating of the optimal path may also include an optimization technique, wherein the optimization technique is one of the linear, convex, non-linear, graph-based and heuristic methods and may, for example include different machine learning and artificial intelligence techniques including deep neural networks and deep reinforcement learning methods. Other variables in the cost may be based on the quality of service, network loading, encountering softwalls, or other variables that may increase or decrease the cost of traversing a path or a subpath.

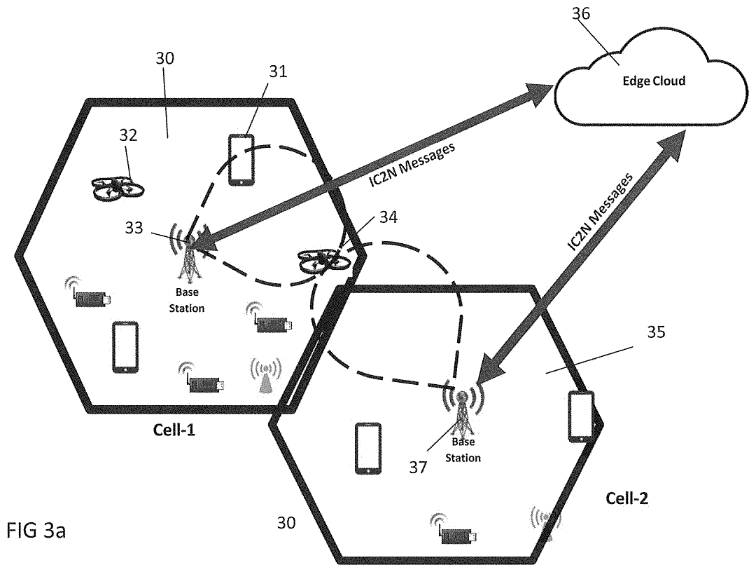

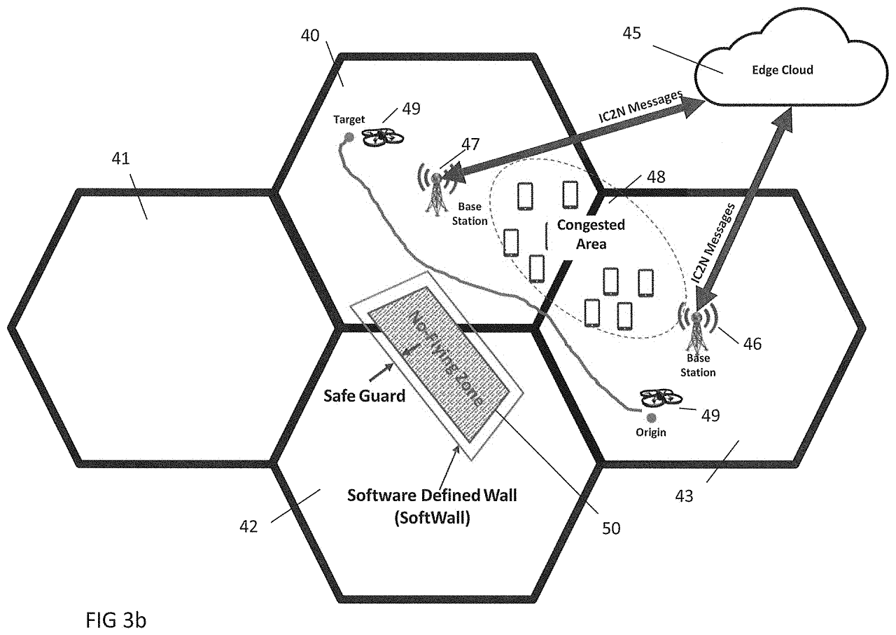

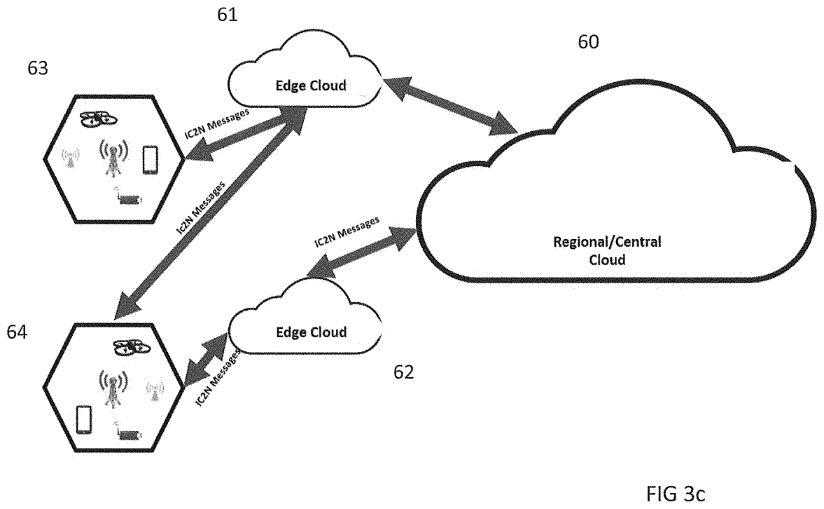

With reference to FIG. 3a, there is shown an exemplary architecture of the system of the present disclosure. There is shown two areas which have cellular coverage, cell coverage area 30 and cell area coverage 35, shown as Cell-1 and Cell-2, respectively. Within cell coverage area 30, there is shown base station 33, which, as known by those skilled in the art, provides communication services to user devices such as user device 31. Additionally, base station 33 may provide services to UAV 32 and UAV 34. In view of the location shown for UAV 34, UAV 34 may also be in communication with base station 37 in cell coverage area 35.

Optimal paths may be dynamically and collaboratively computed at the edge/regional/central network clouds using both local and global information from different sources. FIG. 3a also shows an exemplary configuration wherein base station 33 and base station 37 are in communication with edge cloud 36 associated with a mobile network such as mobile network 6. The communication interface between edge cloud 36 and base stations 30, 35 may include an interface to share IC2N messages directed to or from UAV 32 and/or UAV 34. Such IC2N messages may include source and destinations for UAV 32 or UAV 34, route data, route optimization and other information collected by or derived by the UAV management and control module 20.

FIG. 3b shows another exemplary configuration showing cell coverage areas 40, 41, 42, and 43 and wherein base stations 46, 47 are in communication with edge cloud 45 associated with a network such as network 6. An interface to send and receive IC2N messages between edge cloud 45 and base stations 46, 47 for communication with UAV 49. In this example, UAV 49 is programmed to travel from an origin in cell coverage area 43 to a target destination in cell coverage area 40 as shown.

Continuing with this example, the UAV management and control module 20, may determine an optimal route between the origin and target destination shown by the green line. It will be noted that the optimal route is not necessarily the most direct route between the origin and target destination, but rather is computed to avoid flying through congested area 48 and the no-flying zone 50. Congested area 48 may include either an area with congested UAV traffic and/or an area in which the network is congested based on location, time of day, special events, or other network loading factors.

With respect to the no-flying zone, there is shown a software defined wall (“softwall”) around the no-flying zone 50. Softwalls may, for example, be defined by position coordinates around no-flying zones that are computed using information from public/private agencies and other possible sources and providing for an additional margin of error for compliance with the no-flying zones. The safeguard established by the softwall may, for example, be determined based the precision of the UAV localization technology such as GPS accuracy, or the reliability and/or stability of the target generating the no-flying zone. Any other factors may also be considered in generating the softwall, including, for example, the differences in the sensitivity of the no-flying zone such as an airport, a presidential motorcade, or a professional sporting event and the potential consequences if such a no-flying zone is breached. The softwalls may be static in the case of the airport example or dynamic in the case of the presidential motorcade example. The UAV traffic management and control module 20 may coordinate and collaborate with the UTM and other UAS operators to adaptively update and communicate the optimal path to the UAV 49 based on the static and updated dynamic softwalls, changes in network congestion, weather, emergencies, special events and other factors.

Components of the UAV traffic management and control system may be distributed among edge, regional and/or central clouds as illustrated in the exemplary configuration of FIG. 3c. Such components may be realized physically or instantiated virtually using different technologies. Using such edge cloud technology may foster benefits such as minimizing communication delay between the traffic management and control system and UVAs and among UVAs. Such communications using the IC2N messages may include a variety of information and data. For example, the IC2N messages may contain the coordinates and related information of the optimal path. By receiving the optimal paths, the UAV navigator and optimal motion planning within the UAV enable the navigation of the UAV over the optimal paths and in coordination with local sensory information, obstacle avoidance mechanism, softwalls and other UAV navigation modules. In an aspect, IC2N messages can be compressed, encoded & encrypted at the source and decompressed, decoded and decrypted at the destination using different techniques.

FIG. 3c shows an exemplary configuration of a hierarchal cloud network configuration in which a regional or central network cloud 60 may be in communication with edge clouds 61, 62 and ultimately cell towers located in cell coverage area 63 and cell coverage area 64. All communication interfaces are shown to support the IC2N messages between the UAV traffic management and control module 20 and the UAVs in cell coverage areas 63, 64.

In addition to developing optimal paths for UAVs, it may be recognized that certain UAVs may receive priority, meaning that the optimal path developed for a UAV may be a relative optimal path. In other words, while a path may be optimal for two different UAVs, the UAV with a higher priority may be assigned the optimal path and the UAV with a lower priority may be given a sub-optimal path that is relatively optimal in view of its priority. Accordingly, within the scope of the present disclosure, priority-based optimal paths may be constructed based on the priority of services for different UAVs. Among these, mission critical services may be assigned the highest priority, thereby allowing UAVs traveling on networks such as the FirstNet infrastructure may be giving the highest priority. Optimal paths may also be prioritized based on service level agreements or quality of service metrics, including, for example, the contracted travel and latency times associated with UAVs operating on the mobile network. Other criteria may also be considered, for example, the interference level the UAV traffic may create on the mobile communication networks. In such a scenario, the cost of UAVs traversing over congested network areas are higher, meaning the cost of navigating UAVs over some paths may be more expensive under certain circumstances. Thus, network cost may be a factor based on different business policies and through an agreement with a user.

The system and method of the present disclosure may also detect UAVs using various mechanisms and sensors. Accordingly, the optimal network reconfiguration module 27 can optimally establish network reconfiguration and dynamically set or reset network parameters to track other UAVs and reliably communicate with such other UAVs. In an embodiment, optimal network reconfiguration module 27 includes optimal beamforming at eNB/gNB in LTE/5G networks as shown in FIG. 3. Moreover, the UAV path and traffic measurement module 15 may measure KPIs related to moving UAVs and their respective services they receive. Such measurements and KPIs may be used for computing the optimal paths and reconfiguring the networks.

Methods of Use. In an aspect, users and UAS operators may register with the system and interact with the system after proper authentication and authorization. In interacting with the system, users may access the information provided by system, including for example, optimal paths, UAV locations, UAV KPIs, alarms, and the like either directly from the system or in-directly via the UTM. Likewise, user inputs may provide information that the system to enable the computation of optimal paths or other functions. Custom defined constraints such as the power and capacity of UAVs are examples of other information that users may provide to the system.

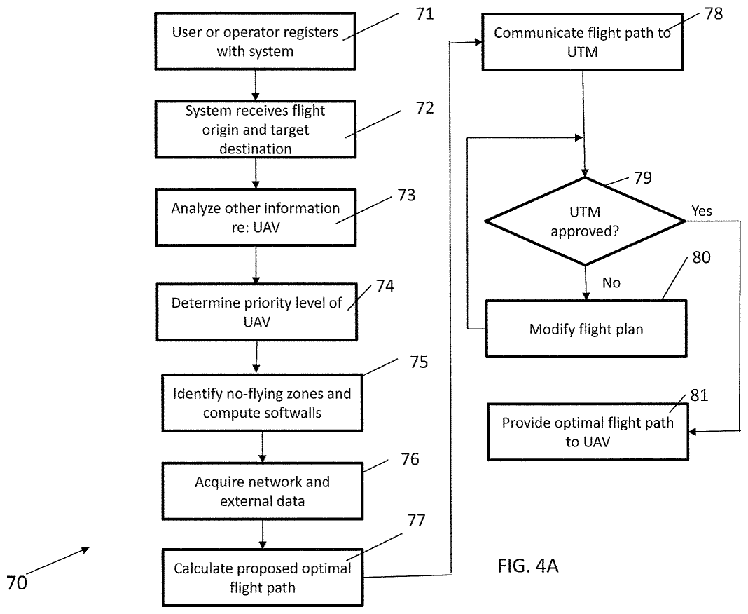

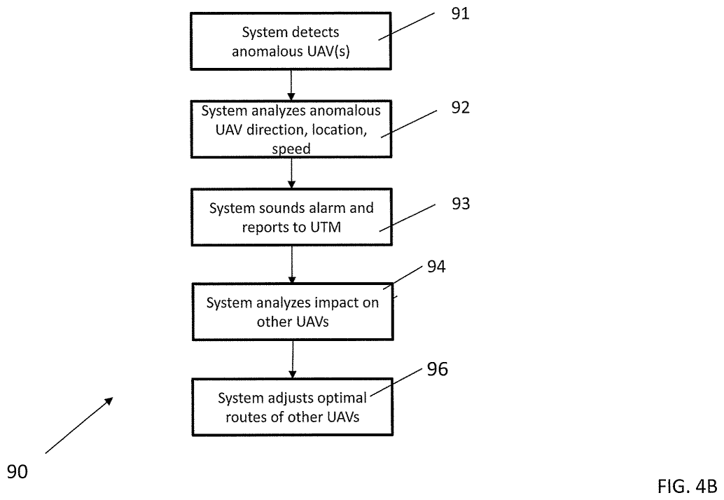

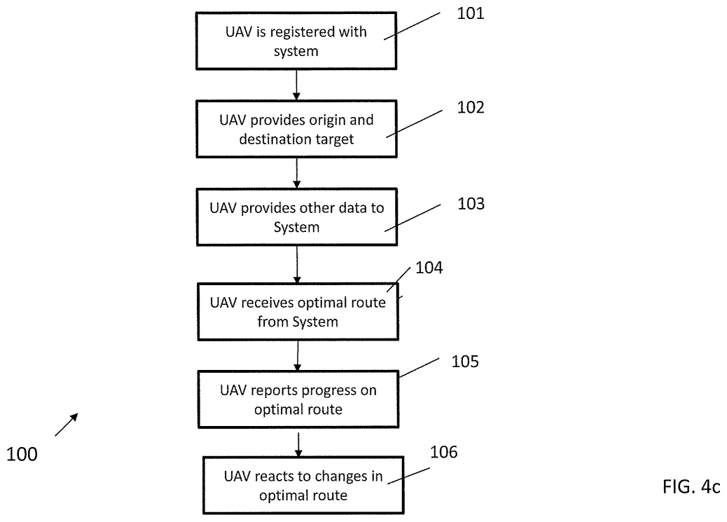

With reference to FIG. 4a, there is shown an exemplary method 70 which may be implemented by a processor executing instructions stored in memory. At 71, the user or UAV operator registers and is authenticated with the UAV traffic management and control system 20. At 72, the UAV traffic management and control system 20 receives user or operator inputs with respect to the origin and target destination of the UAV flight. While the current example shows these as user inputs, in an aspect, the UAV traffic management and control system 20 may receive such inputs from direct communication with the UAV. At 73, other information relating to the UAV is received and analyzed. Such other information may include, for example, key performance indicators (KPIs) for the network and the UAV, quality of service commitments and other information relating to the UAV and its flight pattern. At 74, the priority level of the UAV may be determined.

The method 70 continues at 75 at which no-flying zones in and around the flight path are identified and softwalls are computed. At 76, network loading data and extrinsic data is received and analyzed by the UAV traffic management and control system 20. Such extrinsic data may, for example, include weather data, event data, emergency data, and any other data which may affect the flight path. At 77, the traffic management and control system 20 calculates a proposed optimal flight path for the UAV. At 78, the proposed optimal flight path is sent to the UTM 16. At 79, the UTM 16 either approves, rejects, or suggests modifications to the proposed optimal flight plan. If the UTM 16 rejects the proposed optimal flight plan, the traffic management and control system 20 may modify the flight plan at 80 and resubmit to the UTM 16 for approval. If the UTM approves the flight plan, the traffic management and control system 20 conveys the optimal flight plan to the UAV.

With reference to FIG. 4b, there is shown an exemplary process 90 wherein the traffic management and control system 20 detects an anomalous UAV which may, for example, be an unregistered UAV, a UAV behaving dangerously or erratically either by malfunction or by design, a UAV about to enter into a no-fly zone, or a UAV containing a hazardous payload. At 91, the traffic management and control system 20 detects the anomalous UAV. At 92, the traffic management and control system 20 analyzes data collected regarding the anomalous UAV, including its 3-dimensional location, speed, direction, and other data relating to its flight path. Such other data may be a recognition that the anomalous UAV may have been deployed by a first responder and therefore may have higher priority than other registered UAVs. At 93, the traffic management and control system 20 sounds and alarm and may report the anomalous UAV to the UTM 16. At 94, the impact on other registered UAVs is analyzed. At 95, adjustments to the optimal paths of other registered is revised and sent to the other registered UAVs.

With reference to FIG. 4c, there is shown an exemplary process 100 wherein receipt of the optimal path is shown from the perspective of the UAV and/or the UAV operator. At 101, the UAV is registered and authenticated with the traffic management and control system 20, either directly by the UAV, by the UAV operator, or the UTM 16. At 102, the UAV provides origin and destination target information to the traffic management and control system 20. The UAV may provide this directly, or it may be provided by the UAV operation or the UTM 16. At 103, the UAV may provide other information to the traffic management and control system 20, including quality of service, key performance indicators, priority level, and other data that may affect its optimal route. At 104, the UAV receives the optimal path from the traffic management and control system 20. At 105, the UAV, following the optimal path, provides updates on progress to the traffic management and control system 20. Such updates may include reports on UAV traffic congestion, obstacles encountered, speed and direction, and other data. At 106, the UAV continues monitoring communication from the traffic management and control system 20 and reacts to updates to the optimal path received in real time and adjusts its path accordingly.

A UAV trajectory map 3 may be included in the traffic management and control system 20. The system and method of the present disclosure may also store a copy of optimal paths and the actual UAV trajectories in its internal database to construct a UAV trajectory map 3 that can be used in other applications and further studies. In one embodiment, such information may be used for optimal path planning in future and may serve as the basis for machine learning based path planning.

It will be understood that the methods described herein are exemplary only and the steps set forth do not necessarily need to be executed in any particular order, nor are all steps required to be performed. In an aspect, the traffic management and control system 20 may issue commands to reconfigure network resources to optimize the network performance. In an aspect, network congestion may be constantly monitored and adjustments to optimal flight paths may be made in response to that monitoring.

In view of the foregoing, the disclosure provides a unique architecture in which optimal paths for navigating multiple UAVs using the cellular mobile network can be computed in collaboration and coordination with UTM. Registered customer may also provide their constraints and the system and method may then compute optimal paths that satisfy customer needs and certify the same with the UTM. Compared to other systems, the system and method to determine optimal paths disclosed herein are safe, effective and secure in the sense that, for example, the optimal paths avoid no-flying zones and areas that the communication network is congested. Moreover, the UTM interfaces provide an additional measure of security in that the flight patterns may minimize and/or eliminate damages and interruptions to public and private services and improve QoS/QoE for both UAV and network users.

This system is complimentary to the UTM system and may interoperate with other UAS operators. The system and method are a practical application that provides for the real-time or near-real-time navigation of UAVs as it provides the most updated view of UAV traffic with low latency to command and control UAVs over the air.

Network Description. The system and method of the present disclosure may be implemented in a 4G/LTE, LTE-A, or 5G network or another advanced network. In the 5G context, the system and method of the present disclosure may be implemented and offered by operators to customers as part of 5G slices.

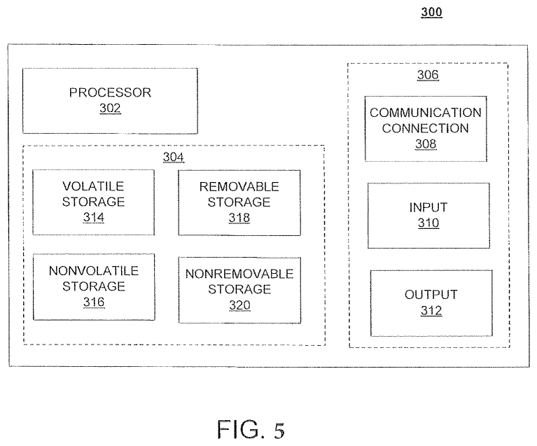

FIG. 5 is a block diagram of network device 300 that may be connected to the network described in FIG. 1 or which may be a component of such a network. Network device 300 may comprise hardware or a combination of hardware and software. The functionality to facilitate telecommunications via a telecommunications network may reside in one or combination of network devices 300. Network device 300 depicted in FIG. 5 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 5 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength. As evident from the description herein, network device 300 is not to be construed as software per se.

In addition to processor 302 and memory 304, network device 300 may include an input/output system 306. Processor 302, memory 304, and input/output system 306 may be coupled together (coupling not shown in FIG. 5) to allow communications between them. Each portion of network device 300 may comprise circuitry for performing functions associated with each respective portion. Thus, each portion may comprise hardware, or a combination of hardware and software. Accordingly, each portion of network device 300 is not to be construed as software per se. Input/output system 306 may be capable of receiving or providing information from or to a communications device or other network entities configured for telecommunications. For example, input/output system 306 may include a wireless communication (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

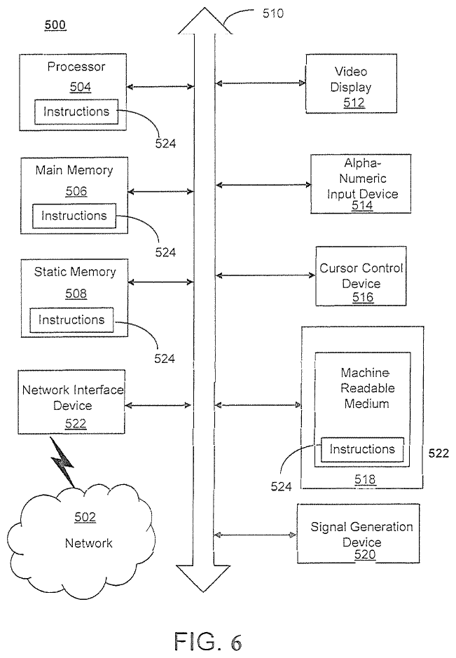

FIG. 6 depicts an exemplary diagrammatic representation of a machine in the form of a computer system 500 within which a set of instructions, when executed, may cause the machine to perform any one or more of the methods described above. One or more instances of the machine can operate, for example, as processor 302, server 112, mobile device 101, in 102, MME 103, and other devices of FIG. 1 and FIG. 2. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, internet of things (IOT) device (e.g., thermostat, sensor, or other machine-to-machine device), or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid-state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

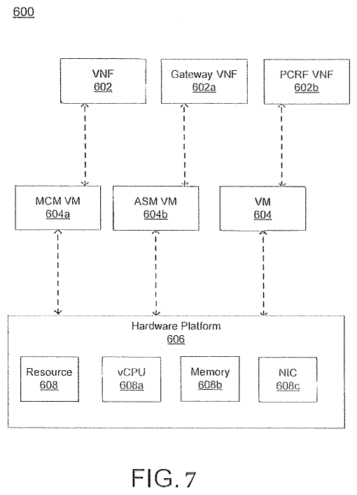

FIG. 7 is a representation of an exemplary network 600. Network 600 (e.g., network 111) may comprise an SDN—that is, network 600 may include one or more virtualized functions implemented on general purpose hardware, such as in lieu of having dedicated hardware for every network function. That is, general purpose hardware of network 600 may be configured to run virtual network elements to support communication services, such as mobility services, including consumer services and enterprise services. These services may be provided or measured in sessions.

A virtual network functions (VNFs) 602 may be able to support a limited number of sessions. Each VNF 602 may have a VNF type that indicates its functionality or role. For example, FIG. 7 illustrates a gateway VNF 602a and a policy and charging rules function (PCRF) VNF 602b. Additionally or alternatively, VNFs 602 may include other types of VNFs. Each VNF 602 may use one or more virtual machines (VMs) 604 to operate. Each VM 604 may have a VM type that indicates its functionality or role. For example, FIG. 7 illustrates a management control module (MCM) VM 604a, an advanced services module (ASM) VM 604b, and a DEP VM 604c. Additionally or alternatively, VMs 604 may include other types of VMs. Each VM 604 may consume various network resources from a hardware platform 606, such as a resource 608, a virtual central processing unit (vCPU) 608a, memory 608b, or a network interface card (NIC) 608c. Additionally or alternatively, hardware platform 606 may include other types of resources 608.

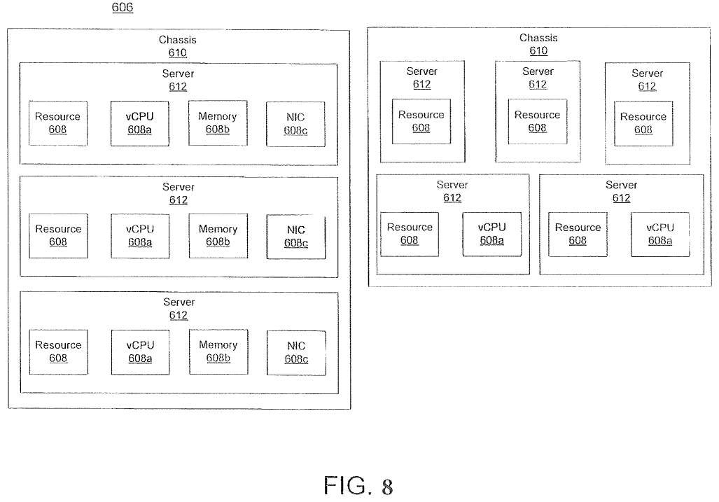

While FIG. 7 illustrates resources 608 as collectively contained in hardware platform 606, the configuration of hardware platform 606 may isolate, for example, certain memory 608c from other memory 608c. FIG. 8 provides an exemplary implementation of hardware platform 606.

Hardware platform 606 may comprise one or more chasses 610. Chassis 610 may refer to the physical housing or platform for multiple servers or another network equipment. In an aspect, chassis 610 may also refer to the underlying network equipment. Chassis 610 may include one or more servers 612. Server 612 may comprise general purpose computer hardware or a computer. In an aspect, chassis 610 may comprise a metal rack, and servers 612 of chassis 610 may comprise blade servers that are physically mounted in or on chassis 610.

Each server 612 may include one or more network resources 608, as illustrated. Servers 612 may be communicatively coupled together (not shown) in any combination or arrangement. For example, all servers 612 within a given chassis 610 may be communicatively coupled. As another example, servers 612 in different chasses 610 may be communicatively coupled. Additionally, or alternatively, chasses 610 may be communicatively coupled together (not shown) in any combination or arrangement.

The characteristics of each chassis 610 and each server 612 may differ. For example, FIG. 8 illustrates that the number of servers 612 within two chasses 610 may vary. Additionally, or alternatively, the type or number of resources 610 within each server 612 may vary. In an aspect, chassis 610 may be used to group servers 612 with the same resource characteristics. In another aspect, servers 612 within the same chassis 610 may have different resource characteristics.

Given hardware platform 606, the number of sessions that may be instantiated may vary depending upon how efficiently resources 608 are assigned to different VMs 604. For example, assignment of VMs 604 to resources 608 may be constrained by one or more rules. For example, a first rule may require that resources 608 assigned to a VM 604 be on the same server 612 or set of servers 612. For example, if VM 604 uses eight vCPUs 608a, 1 GB of memory 608b, and 2 NICs 608c, the rules may require that all these resources 608 be sourced from the same server 612. Additionally, or alternatively, VM 604 may require splitting resources 608 among multiple servers 612, but such splitting may need to conform with certain restrictions. For example, resources 608 for VM 604 may be able to be split between two servers 612. Default rules may apply. For example, a default rule may require that all resources 608 for a given VM 604 must come from the same server 612.

An affinity rule may restrict assignment of resources 608 for a particular VM 604 (or a particular type of VM 604). For example, an affinity rule may require that certain VMs 604 be instantiated on (that is, consume resources from) the same server 612 or chassis 610. For example, if VNF 602 uses six MCM VMs 604a, an affinity rule may dictate that those six MCM VMs 604a be instantiated on the same server 612 (or chassis 610). As another example, if VNF 602 uses MCM VMs 604a, ASM VMs 604b, and a third type of VMs 604, an affinity rule may dictate that at least the MCM VMs 604a and the ASM VMs 604b be instantiated on the same server 612 (or chassis 610). Affinity rules may restrict assignment of resources 608 based on the identity or type of resource 608, VNF 602, VM 604, chassis 610, server 612, or any combination thereof.

An anti-affinity rule may restrict assignment of resources 608 for a particular VM 604 (or a particular type of VM 604). In contrast to an affinity rule—which may require that certain VMs 604 be instantiated on the same server 612 or chassis 610—an anti-affinity rule requires that certain VMs 604 be instantiated on different servers 612 (or different chasses 610). For example, an anti-affinity rule may require that MCM VM 604a be instantiated on a particular server 612 that does not contain any ASM VMs 604b. As another example, an anti-affinity rule may require that MCM VMs 604a for a first VNF 602 be instantiated on a different server 612 (or chassis 610) than MCM VMs 604a for a second VNF 602. Anti-affinity rules may restrict assignment of resources 608 based on the identity or type of resource 608, VNF 602, VM 604, chassis 610, server 612, or any combination thereof.

Within these constraints, resources 608 of hardware platform 606 may be assigned to be used to instantiate VMs 604, which in turn may be used to instantiate VNFs 602, which in turn may be used to establish sessions. The different combinations for how such resources 608 may be assigned may vary in complexity and efficiency. For example, different assignments may have different limits of the number of sessions that can be established given a particular hardware platform 606.

For example, consider a session that may require gateway VNF 602a and PCRF VNF 602b. Gateway VNF 602a may require five VMs 604 instantiated on the same server 612, and PCRF VNF 602b may require two VMs 604 instantiated on the same server 612. (Assume, for this example, that no affinity or anti-affinity rules restrict whether VMs 604 for PCRF VNF 602b may or must be instantiated on the same or different server 612 than VMs 604 for gateway VNF 602a.) In this example, each of two servers 612 may have sufficient resources 608 to support 10 VMs 604. To implement sessions using these two servers 612, first server 612 may be instantiated with 10 VMs 604 to support two instantiations of gateway VNF 602a, and second server 612 may be instantiated with 9 VMs: five VMs 604 to support one instantiation of gateway VNF 602a and four VMs 604 to support two instantiations of PCRF VNF 602b. This may leave the remaining resources 608 that could have supported the tenth VM 604 on second server 612 unused (and unusable for an instantiation of either a gateway VNF 602a or a PCRF VNF 602b). Alternatively, first server 612 may be instantiated with 10 VMs 604 for two instantiations of gateway VNF 602a and second server 612 may be instantiated with 10 VMs 604 for five instantiations of PCRF VNF 602b, using all available resources 608 to maximize the number of VMs 604 instantiated.

Consider, further, how many sessions each gateway VNF 602a and each PCRF VNF 602b may support. This may factor into which assignment of resources 608 is more efficient. For example, consider if each gateway VNF 602a supports two million sessions, and if each PCRF VNF 602b supports three million sessions. For the first configuration—three total gateway VNFs 602a (which satisfy the gateway requirement for six million sessions) and two total PCRF VNFs 602b (which satisfy the PCRF requirement for six million sessions)—would support a total of six million sessions. For the second configuration—two total gateway VNFs 602a (which satisfy the gateway requirement for four million sessions) and five total PCRF VNFs 602b (which satisfy the PCRF requirement for 15 million sessions)—would support a total of four million sessions. Thus, while the first configuration may seem less efficient looking only at the number of available resources 608 used (as resources 608 for the tenth possible VM 604 are unused), the second configuration is actually more efficient from the perspective of being the configuration that can support more the greater number of sessions.

To solve the problem of determining a capacity (or, number of sessions) that can be supported by a given hardware platform 605, a given requirement for VNFs 602 to support a session, a capacity for the number of sessions each VNF 602 (e.g., of a certain type) can support, a given requirement for VMs 604 for each VNF 602 (e.g., of a certain type), a give requirement for resources 608 to support each VM 604 (e.g., of a certain type), rules dictating the assignment of resources 608 to one or more VMs 604 (e.g., affinity and anti-affinity rules), the chasses 610 and servers 612 of hardware platform 606, and the individual resources 608 of each chassis 610 or server 612 (e.g., of a certain type), an integer programming problem may be formulated.

A 5G network may be overlaid on a 4G LTE network. While the 5G network uses similar functional components as a 4G network, 5G is more aggressive in pushing computational resources to the edge of the networks, including instantiating such computation resources in an edge-based cloud. 5G uses massive multiple input—multiple output (MIMO) antennae which are able to generate multiple targeted beams for each user or a group of users and such targeted beams may even follow devices as they traverse the coverage area. This permits reduced power consumption, improved coverage and bandwidth, lower latency (especially at network cloud edges) and increased capacity, thereby improving coverage, speed and capacity. 5G compliant radios on user equipment and UAVs communicate with the 5G network. Additionally, 5G will allow more uses of network access by internet of things devices.

5G networks may be architected such that 5G network slices, namely an end-to-end instance of a network, may be created for each user or a group of users. Such network slices provide full functionality and scalability for enterprise applications. Moreover, network slices provide increased security.

5G networks may be characterized by lower-power cell sites and which such cell sites are compact and deployed more widely with less coverage area each than comparable 4G cell sites. Each cell site is connected to the network backbone and may operate on three different frequency bands, each with its on characteristics. The resultant connectivity is able to provide increases in speed and reduction in latency.

As described herein, a telecommunications system wherein management and control utilizing a software designed network (SDN) and a simple IP are based, at least in part, on user equipment, may provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

In view of the foregoing, the disclosure provides for the navigation of numerous UAVs over a wide area of coverage in an effective, safe and secure manner. In achieving such a capability, there is disclosed collaboration and coordination between UTM and mobile network providers such that global and local information may be optimally utilized and quality of service metrics for both UAV and terrestrial network users may be achieved, without the interruption and damaging public/private services.

While the disclosure has been described in relation to a generic network, it will be understood that the systems and methods disclosed herein may be deployed in both cellular networks and information technology infrastructure and support current and future use cases. Moreover, the architecture may also be used by carrier or third-party vendors to augment networks on the edge.

As described herein, a telecommunications system wherein management and control utilizing a software designed network (SDN) and a simple IP are based, at least in part, on user equipment, may provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a telecommunications system have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

While a telecommunications system has been described in connection with the various examples of the various figures, it is to be understood that other similar implementations may be used, or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, a telecommunications system as described herein should not be limited to any single example, but rather should be construed in breadth and scope in accordance with the appended claims.

In describing preferred methods, systems, or apparatuses of the subject matter of the present disclosure as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. In addition, the use of the word “or” is generally used inclusively unless otherwise provided herein.

This written description uses examples to enable any person skilled in the art to practice the claimed subject matter, including making and using any devices or systems and performing any incorporated methods. The patentable scope of the disclosed subject matter is defined by the claims and may include other examples that occur to those skilled in the art (e.g., skipping steps, combining steps, or adding steps between exemplary methods disclosed herein). Such other examples are intended to be within the scope of the claims if they have structural elements that do not differ from the literal language of the claims, or if they include equivalent structural elements with insubstantial differences from the literal languages of the claims.

What is claimed:

1. A method comprising:
receiving a request to create an optimal flight path for an unmanned aerial vehicle (UAV), wherein the request includes an origin and a destination of a UAV flight;
receiving an indicator of network performance between the origin and destination;
determining if there is a no-fly zone between the origin and the destination;
creating a softwall surrounding the no-fly zone based on the identifying step;
generating the optimal flight path for the UAV based on the indicator and avoidance of the softwall; and
transmitting the optimal flight path to the UAV.

2. The method of claim 1 further comprising receiving a priority for a flight of the UAV and wherein generating the optimal flight path is further based on the priority for the flight.

3. The method of claim 1 wherein generating the optimal flight path is further based on quality of service.

4. The method of claim 1 wherein generating the optimal flight path is further based on a physical limitation of the UAV.

5. The method of claim 1 further comprising receiving an additional data input and wherein the generating the optimal flight path is further based on the additional data input, and wherein the additional data input is one of weather, an emergency or an event.

6. The method of claim 1 further comprising receiving an additional data input and wherein the generating the optimal flight path is further based on the additional data input, wherein the additional data input relates to a dynamic no-fly zone and the method further comprises creating a softwall surrounding the dynamic no-fly zone, generating an updated optimal flight path, and transmitting the updated optimal flight path to the UAV during the UAV flight.

7. The method of claim 1 wherein the optimal flight path is transmitted to an external system and the transmitting the optimal flight path to the UAV step is based on acceptance of the optimal flight path by the external system.

8. The method of claim 1 further comprising detecting an anomalous UAV, generating an updated optimal flight path further based on the anomalous UAV, and transmitting the updated optimal flight path to the UAV during the UAV flight.

9. The method of claim 1 further comprising receiving feedback from the UAV, generating an updated optimal flight path further based on the feedback, and transmitting the updated optimal flight path to the UAV during the UAV flight.

10. The method of claim 1 further comprising reconfiguring the underlying network based on the indicator of network performance.

11. A method comprising:
receiving an origin and a destination for a flight associated with an unmanned aerial vehicle (UAV);
calculating an optimal flight path for the UAV between the origin and the destination; and
transmitting the optimal flight path to the UAV,
wherein the calculating step comprises optimizing a cost as a function of a variable and wherein the variable is one of the distance between the origin and the destination, encountering obstacles, or network performance metrics.

12. The method of claim 11 wherein the distance between the origin and the destination is divided into a plurality of segments and wherein any segment of the plurality of segments within a softwall are excluded from the optimal flight path.

13. The method of claim 11 wherein the calculating step comprises an optimization technique, wherein the optimization technique is one of linear, convex, non-linear, graph-based and heuristic techniques.

14. The method of claim 11 wherein the calculation step comprises one of using machine learning techniques, artificial intelligence techniques, deep neural networks or deep reinforcement learning.

15. The method of claim 11 wherein an additional variable is a constraint such that a travel power level needed to traverse a path is less that an available power level of the UAV.

16. The method of claim 11 wherein an additional variable is a priority level of a flight of the UAV.

17. The method of claim 11 wherein an additional variable is avoidance of softwalls.

18. A system comprising:
an input-output interface;
a processor coupled to the input-output interface wherein the processor is further coupled to a memory, the memory having stored thereon executable instructions that when executed by the processor cause the processor to effectuate operations comprising:
receiving an origin and a destination for a UAV flight;
acquiring key performance indicators relating to the UAV flight;
identifying constraints associated with the UAV flight;
calculating an optimal path for the UAV flight based on the origin and the destination, the key performance indicators, and the constraints; and
transmitting the optimal path to the UAV.

19. The system of claim 19 wherein the operations further include receiving an additional input after the transmitting step, calculating a revised optimal path based in part on the additional input, and transmitting the revised optimal path to the UAV during the UAV flight.

20. The system of claim 18 wherein the operations further include identifying a no-fly zone in proximity of a possible flight path between the origin and the destination, calculating a softwall surrounding the no-fly zone, calculating a revised optimal path based in part on the avoidance of the softwall, and transmitting the optimal path to the UAV.
